(19) United States
(12) Patent Application Publication
(10) Pub. No.: US 2010/0117864 A1
(43) Pub. Date: May 13, 2010

(54) Vehicle identification and speed detection method and system

(75) Inventor: Kirill Makukhin, Redcliffe (AU)

Correspondence Address: Kirill Makukhin, 20 Gale St, Queensland, Redcliffe, 4020, omitted

(73) Assignee: Kirill Makukhin, Redcliffe (AU)

(21) Appl. No.: 12/269,060

(22) Filed: Nov. 12, 2008

(51) Int. Cl. G08G 1/01

(52) U.S. Cl. 340/936

(57) ABSTRACT

A system and method to provide traffic surveillance and more specifically, the detection and identification of vehicles whose average speed exceeds a legal limit anywhere for an extended part of the roadway by means of detection of the time difference between passing by at least two check points.

### REFERENCES CITED

U.S. Patent Documents

| | | |
|---|---|---|
| 3,522,611 | August 1970 | Maronde |
| 4,234,923 | November 1980 | Eshraghian |
| 4,866,438 | September 1989 | Knisch |
| 4,878,248 | October 1989 | Shyu |
| 5,204,675 | April 1993 | Sekine |
| 5,310,999 | May 1994 | Claus |
| 5,381,155 | January 1995 | Gerber |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates to vehicle traffic control, traffic surveillance, and more specifically to the detection and identification of vehicles whose speed exceeds a legal limit.

### BACKGROUND OF THE INVENTION

The control and decreasing of speed limit violations is both a safety and traffic congestion issue. The number of highway accidents may be reduced if drivers obey the speed limits. On the other hand, traffic accidents are a major cause of traffic congestion.

At the present time the detection of vehicle speed is based primarily on such methods as Doppler radar, laser beam, sensing coils on the roadway (as in U.S. Pat. No. 4,234,923), or parallel infrared beams. All the said methods measure the vehicle speed only in a particular point of the road. In many countries, according to the law, such points must be clearly identified by signs and said points are well known by motorists. Therefore, the speeding vehicle can easily avoid a fine by decreasing their speed when approaching the measuring point.

In addition, most of speed detection devices require frequent calibration and calibration certificates are often required as evidence in court. In fact, in some cases the absence of a calibration certificate can help acquit an accused party.

### BRIEF SUMMARY OF THE INVENTION

In accordance with the present invention there is provided a system and method to provide traffic surveillance and more specifically, the detection and identification of vehicles whose speed exceeds a legal limit anywhere for an extended part of the roadway.

The system consists of at least two detectors, installed on a roadway with known distance between each other. Each detector comprising means to identify the vehicle and to detect the exact time when the vehicle passes by. An average speed of the vehicle is calculated using the time difference of passing by the detectors and the distance between detectors.

The system can further detect if the vehicle is speeding and present relevant information, including the license plate number and photograph of the operator to police violation database or to a police officer.

### BRIEF DESCRIPTION OF THE DRAWINGS

The various features of the present invention may be more fully understood with reference to the following detailed description taken in conjunction with the accompanying drawings:

FIG. 1 is a perspective view showing an appearance of the detectors installed along a roadway;

FIG. 2 illustrates a detailed block diagram of the invention.

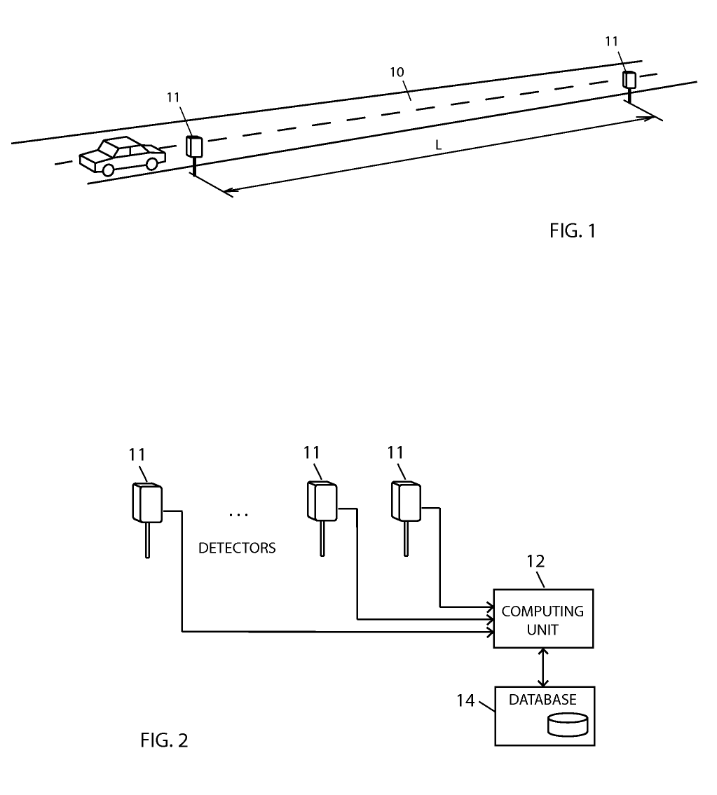

### DETAILED DESCRIPTION OF THE INVENTION

The system consists of at least two detectors (11), installed on a roadway (10) with known distance between each other (L), and a computing unit (12) which collects information from the detectors, analyzes it, stores in the police database (14) or together with other vehicle registration information sends it to a police officer.

The detector detects and clearly identifies a vehicle, records the exact time of the vehicle passing by and optionally takes a photograph of the vehicle and the operator. The detection and identification could be performed by reading and recognition of a license plate number (for example as in U.S. Pat. Nos. 3,522,611, 4,866,438, 4,878,248, 5,381,155). Another method of identification is by means of electronic transponder widely used for automatic roadway toll charging system such as in U.S. Pat. Nos. 5,204,675 and 5,310,999.

The identities of the vehicles along with the time of passing by are being compared in the computing unit and an average speed of each vehicle is being calculated as:

V=L/(T₂-T₁), where

V—average speed,

T₁—the time of passing by the detector N,

T₂—the time of passing by next sequential detector N+1,

L—the distance between the pair of detectors N and N+1.

If the average speed exceeds the limit, it is obvious that the vehicle has exceeded the speed limit at least for some part of the section of the road between detectors and at least it had the speed equal to V.

The relevant information, which may include identity of the car, average speed, license plate number, photograph of the vehicle, photograph of the operator is transmitted to a police officer or to a database and further may be used to issue traffic violation citations to the drivers of the vehicle or to collect traffic statistics.

What is claimed is:

1. A method of traffic control for identification of moving vehicles on a roadway and for detection an average speed of the said vehicles, the method including:
(a) automatically identifying the vehicles on at least two points of a roadway with a distance at least 10 m between each other and recording the time of passing by the said points;
(b) automatically, in a computing unit, calculating the average speed of the said vehicles as:
distance between points divided by time difference of passing by the said points;
(c) automatically, in a computing unit, matching the identity of the said vehicles with a database of registered vehicles and deriving information associated with the matched vehicles.

2. A method as in claim 1 that further determines if any of the vehicles are speeding because their speed exceeds a predetermined speed limit.

3. A method as in claim 1 wherein the vehicles are identified by reading a license plate number by means of camera, computer system and optical character recognition software.

4. A method as in claim 1 wherein the vehicles are identified by reading identification information from an electronic transponder means installed in the said vehicles.

5. A traffic control system for the identification of moving vehicles on a roadway and detection of an average speed of the said vehicles, the system including:
(a) at least two detectors comprising means for automatically identifying the vehicles and for recording the time of passing by, the said detectors are installed along a roadway with a distance at least 10 m between each other;
(b) a computing unit for the collection of data received from the said detectors and for calculating the average speed of the said vehicles;
(c) a computer database of vehicles' identities and associated information about the vehicle associated with each vehicle identity;

6. A system as in claim 5 and further including systems:
(a) for determining if any of the vehicles are speeding vehicles because their speed exceeds the predetermined speed limit;
(b) for presenting information about speeding vehicles to police violation database to issue traffic violation citations to drivers of the speeding vehicles;

7. A system as in claim 5 and further including means for taking and storing photographs of the said vehicles and their operators along with said associated information about the vehicles.

8. A system as in claim 5 wherein the means for the identification of moving vehicles comprises a camera with computer system and optical character recognition software for reading and recognizing of the license plate number.

9. A system as in claim 5 wherein the means for the identification moving vehicles comprises an electronic transponder means installed in the vehicle and a reader means, mounted in the said detectors on a roadway, for receiving the identification information form the vehicle's transponder.
